(19) United States
(12) Patent Application Publication
(10) Pub. No.: US 2003/0103673 A1
(43) Pub. Date: Jun. 5, 2003

(54) Shape searcher

(76) Inventors: Nainesh Rathod, Lafayette, IN (US); Jamie Tan, West Lafayette, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/023,041

(22) Filed: Nov. 30, 2001

(51) Int. Cl. G06K 9/48

(52) U.S. Cl. 382/199

(57) ABSTRACT

The method and program for indexing shapes contained on a digital page for storage in a database for subsequent searching and retrieval includes an indexing routine for generating the database of indexed shapes by removing extraneous information on the digital page, and orienting the shapes in a predetermined orientation for storage in the shape database, and a querying routine for identifying indexed shapes that are similar or identical to a search shape by extracting the search shape from a digital page using the indexing routine and comparing the extracted shape to the indexed shapes in the database.

### FIELD OF THE INVENTION

The present invention generally relates to a method and program for searching a database of shapes and more particularly to a method and program for extracting a search shape from a drawing or file and comparing the search shape to a plurality of indexed shapes stored in a database to identify identical or similar shapes.

### BACKGROUND OF THE INVENTION

Many organizations maintain thousands of drawings, such as engineering and production drawings of various mechanical parts or electrical schematics. Frequently, new projects within the organization require reference to and/or incorporation of portions of the content of previously generated drawings. Often, the desired previously generated drawings may only be located by having knowledge of the content of the drawings associated with a particular project. By knowing the content of the drawings and determining the associated project number, an employee of the organization can obtain a set of drawings that may include the desired content for incorporation into a new drawing or for reference. Even when drawings are stored electronically, for example, in vector format files, a certain degree of familiarity with the content of previously generated drawings is required in order to focus the search to locate a particular object or objects.

Accordingly, it is desirable to provide a method and program for quickly searching through the content of a plurality of drawings to obtain drawings having content that corresponds to a specific search criteria.

### SUMMARY OF THE INVENTION

The present invention provides a method and program (hereinafter referred to simply as “the software”) for extracting a shape from a physical drawing or a computer file (bitmap or vector format) referred to as a digital page, indexing the shape for storage in a database of shapes, or using the extracted shape as search criteria to locate identical or similar shapes already indexed and stored in a pre-existing database. According to the present method, an operator may create a database of shapes by inputting drawings or digital pages containing shapes into a computer system. An indexing routine of the present invention extracts the shape from the drawing or digital page by eliminating extraneous information also contained on the drawing. The extracted shape is then oriented in a predetermined orientation for storage in a database. According to a querying routine of the present invention, the extracted shape may be used as search criteria for comparison to pre-indexed shapes stored in the database.

The features of the present invention described above, as well as additional features, will be readily apparent to those skilled in the art and the invention will be better understood upon reference to the following description and accompanying drawings.

### BRIEF DESCRIPTION OF THE DRAWINGS

FIGS. 1-8 are conceptual drawings of the various steps included in one embodiment of the method of the present invention.

FIG. 9 is a perspective view of one application of the present invention.

FIGS. 10 and 11 are conceptual drawings of the various steps included in the application depicted in FIG. 9.

FIGS. 12-22 are conceptual drawings of the various steps included in another embodiment of the method of the present invention.

### DETAILED DESCRIPTION OF EMBODIMENTS OF THE INVENTION

The exemplary embodiments selected for description below are not intended to be exhaustive or to limit the invention to the precise forms disclosed. Instead, the embodiments have been selected for description to enable one of ordinary skill in the art to practice the invention.

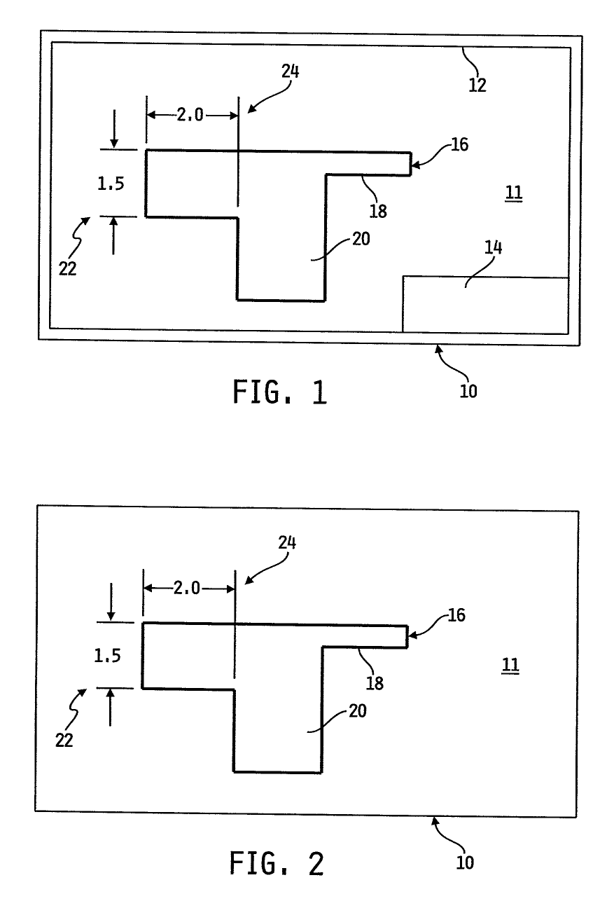

The following description of a first embodiment of the software of the present invention uses, as an example, application of the software to extract, index, and search bitmap or raster images (i.e., drawings in various formats including TIF, GIF, etc.). It should be understood, however, that the various steps and procedures of the present invention are not limited to such an application, and may be applied to index and search shapes contained on drawings or digital pages in various formats. FIG. 1 shows an example of a digital page or physical drawing generally referred to as page 10. It should be understood that page 10 may be stored electronically in a storage medium of a computer system, or exist physically on a printed page. If page 10 exists electronically, it is inputted into the software by being selected using file management software or similar software according to principles well known to those skilled in the art. If page 10 is a physical drawing, it must first be digitized by being inputted into a digitizing device, such as a scanner, which generates a digital page 10 for input into the software for implementing the present invention.

As shown in FIG. 1, page 10 generally includes a background 11, a border 12, a title block 14, and a shape 16. Title block 14 may include various information relating to shape 16 or a project with which shape 16 is associated. Shape 16 includes a perimeter 18 that defines an interior space 20. Page 10 further includes a plurality of other objects such as dimension information 22, 24 and other notes (not shown) relating to shape 16.

Once digital page 10 is inputted, border 12 and title block 14 are removed as show in FIG. 2. It is a standard convention to have a border 12 extending around the perimeter of page 10. It is also typical to include a title block 14 in the lower right hand corner of a drawing. Accordingly, the software according to the present invention locates and identifies the lines defining border 12 and title block 14. The software locates borders by selecting “starting points” very near each edge of the page and “moving” vertically and horizontally toward the center of the page, pixel by pixel, until a black pixel is identified. For example, eight starting points may be used along the bottom of page 10. For each such starting point, the software will move vertically upwardly, pixel by pixel, until a black pixel is identified. After a black pixel is identified for each of the starting points, the locations of the black pixels are inputted into a line fitting algorithm. The algorithm produces as an output an assessment of the quality of the line fit. If the line fit is of a high quality, then the software assumes that a border line segment has been identified. The software determines the width of the border line segment by moving across the width of the line, pixel by pixel, to determine its width in pixels. This process is repeated for all four sides of page 10. Title block 14 is located in a similar manner. Once border 12 and title block 14 are identified, the software deletes those items (draws slightly wider white lines over the existing black lines) as shown in FIG. 2. Accordingly, the only objects remaining on page 10 are shape 16 and any additional objects or information such as dimension information 22, 24.

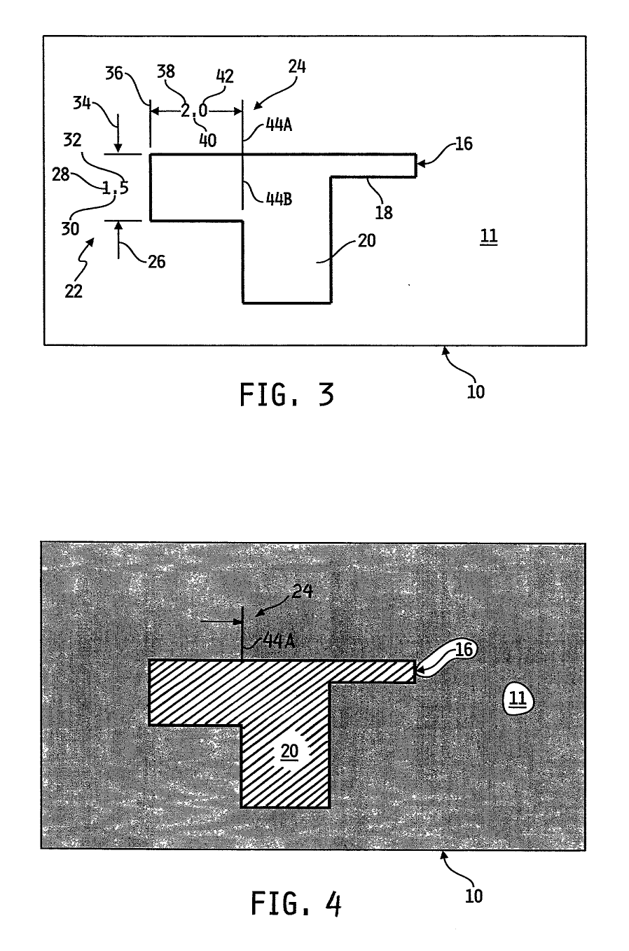

Referring now to FIG. 3, the software next sub-samples or reduces the remaining objects on page 10 to facilitate faster processing in the subsequent steps described below. Any of a variety of image reduction techniques may be employed to produce a scaled down version of the original content of page 10. FIG. 3 also represents the results of a segmentation process which is performed on the reduced objects. According to this process, which employs conventional component labeling techniques, the software scans across page 10, one row of pixels at a time, and identifies black pixels. Connected or adjacent black pixels thus form objects, which are labeled. For example, object 26 includes a dimension line and an arrow that are connected together at the point of the arrow head. Object 28 is the numeral “1” of the dimension “1.5” associated with dimension information 22. Object 30 is the decimal point of the dimension “1.5” associated with dimension information 22. The remaining objects 32, 34, 36, 38, 40, 42, 44A, and 44B are similarly defined by the segmentation process. It should be noted that objects 44A and 44B essentially constitute a single object including a dimension line and an arrow. The single object has been labeled for this description as two separate components 44A, 44B to indicate that a portion of the object (44A) is located on background 11 and another portion of the object (44B) is located within interior space 20 of shape 16.

After all of the objects are identified by the segmentation process described above, all objects except the largest object are removed or deleted from page 10. The software according to the present invention can accurately assume that the largest object on page 10 is shape 16 because the other potentially larger objects (i.e., border 12 and title block 14) have already been removed. The size or enclosed area of each object is determined after a backfilling process wherein background 11 is backfilled according to principles well-known in the art. The beginning point for backfilling background 11 may be selected as a corner point of page 10, where it may be safely assumed that the shape is not the present. If page 10 did not include border 12 (FIG. 1), then the starting point for the backfill procedure is determined by drawing a virtual box around the content of page 10 having a left edge that is slightly to the left of the left most black pixel of page 10, a right edge that is slightly to the right of the right most black pixel of page 10, and top and bottom edges that are vertically above and vertically below the uppermost and lowermost black pixels of page 10, respectively. The software then selects a point on page 10 outside this virtual box to begin the backfilling procedure. After background 11 is filled with the selected color, blue for example, all of the pixels of page 10 are either black or blue except those enclosed within a black pixel border (i.e., interior space 20 of shape 16 and the interior of the “0” of object 42).

The software next converts all pixels which are not blue to black. As a result, the enclosed white pixels described above are replaced by black pixels to create solid objects. Finally, the areas of the objects on page 10 are compared and the largest object is retained. All pixels not contiguous with the largest object (shape 16) are deleted by being converted from black pixels to blue pixels. The result of this procedure is shown in FIG. 4. It should be noted that object 44A is contiguous with shape 16, and thus has survived the above-described process. Object 44B no longer exists because interior space 20 of shape 16 was filled with black pixels (the color black being represented by diagonal lines).

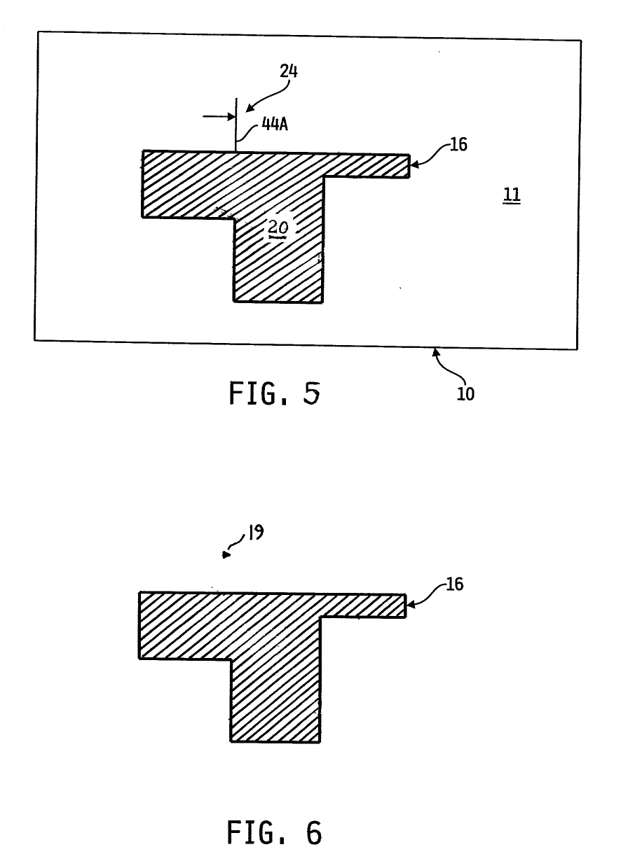

FIG. 5 shows shape 16 after background 11 has been converted from black to white using conventional techniques. As is conventional in engineering drawings and the like, objects such as the dimension line and arrow shaft of object 44A (and any other similar extraneous objects) typically have a width of a single pixel. The software of the present invention makes use of this convention with an erosion procedure which removes a single pixel of width from the perimeter of all objects on page 10 by deleting contiguous pixels along the perimeter of the object. During this procedure, the software removes the dimension line and arrow shaft of object 44A which, as described above, is typically a single pixel in width. As shown in FIG. 6, the only remaining objects surviving this process are shape 16 and a slightly reduced arrow head from object 44A (labeled 19).

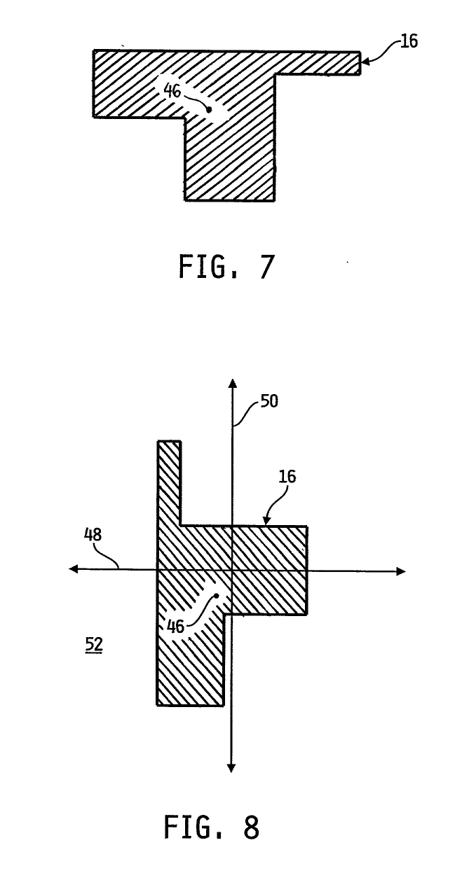

The software again compares the area of the remaining objects, and removes all but the largest object. As a result of this process, arrow head 19 is removed, leaving only shape 16 as shown in FIG. 7.

Finally, shape 16 is rotated into a predetermined orientation to enable faster searching as further described below. In this example, the software calculates the center of mass 46 of shape 16 using known techniques. It should be understood, however, that various ways of defining the predetermined orientation exist. For example, the software could readily be modified to determine the greatest dimension of shape 16, the smallest dimension of shape 16, or some other characteristic of shape 16 which will be located in a predetermined orientation similar to that described below. Once center of mass 46 is located, shape 16 is rotated such that center of mass 46 is positioned, for example, within the lower left quadrant 52 as defined by axes 48, 50 and shown in FIG. 8. As will be further described below, all shapes processed using the software of the present invention will be oriented in a similar manner and stored in a database or compared to a preexisting database of shapes stored according to this procedure. Accordingly, the comparison process of the present invention need only be performed for a single orientation of a particular search shape, thereby reducing the time required for a search operation. Once shape 16 is properly oriented, it is stored in a database with information associating shape 16 with digital page 10.

The above-described process may be executed as an indexing routine and performed off-line for creation of a searchable database of shapes. The process is simply repeated for each inputted drawing or digital page 10. After a searchable database is created, the indexing routine is essentially repeated as the first steps of a querying routine according to the present invention wherein a search shape located on digital page 10 is extracted from digital page 10 according to the process described above. After the search shape is so extracted, the querying routine executes a procedure for comparing the search shape to the indexed shapes stored in the database. Finally, the querying routine outputs a list or an array of thumbnail images corresponding to shapes which are identical or similar to the search shape. The operator may then select a desired shape from the list or array of thumbnail images to bring up information about the drawing or digital page 10 from which the shape was extracted.

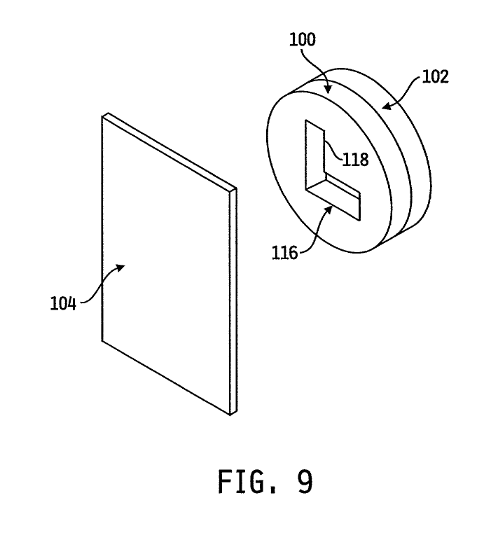

FIGS. 9-11 illustrate one application of the software of the present invention wherein a search is performed to locate drawings of various die and die supports. Referring to FIG. 9, in this application, a die 100 is used in conjunction with a die support 102 to cut stock material 104. Die 100 includes a shape 116 defining the desired shape of the part to be cut from stock 104 according to well known manufacturing techniques. Shape 116 is defined by a perimeter 118. Die support 102 includes a similar shape (not shown in FIG. 9) which is slightly larger than die shape 116 so as to permit the cut piece of stock material 104 to freely move through die support 102 during the punching or cutting process. To locate any drawings containing shapes corresponding to die shape 116, or other drawings corresponding to die 100, a drawing or digital page containing die shape 116 is inputted into the software of the present invention and processed as described above. To locate drawings of die support 102, however, the tolerances of die support 102 that define the shape of die support 102 must be accommodated.

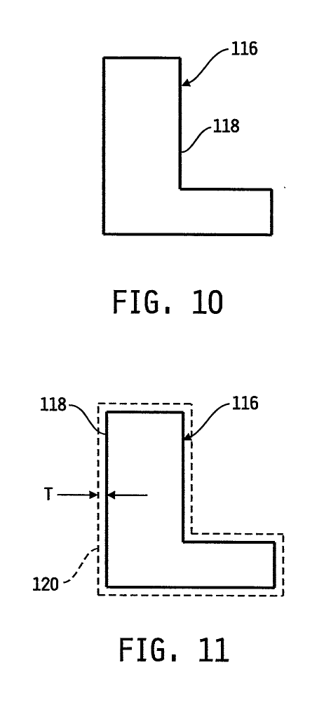

FIG. 10 shows die shape 116 defined by perimeter 118. FIG. 11 shows perimeter 118 and die support shape 120 which is larger than perimeter 118 by a tolerance “T.” To efficiently search for drawings including die support shape 120 from an inputted drawing or digital page 10 including die shape 116, the present invention first extracts die shape 116 and searches the applicable database to find all shapes that include or encompass die shape 116. All other shapes in the database are, by definition, smaller than die shape 116 and cannot possibly be die support shape 120. This process eliminates an entire group of shapes from the database to speed up the subsequent search. Next, die shape 116 is enlarged in all directions by tolerance “T,” such that die shape 116 corresponds to die support shape 120. Finally, the resulting, enlarged shape is compared to the remaining shapes in the database to identify the shape(s) that contain the enlarged shape. The resulting shapes should be included in drawings of die support shape 120 and drawings of die 102.

Another embodiment of the software according to the present invention is shown in FIGS. 12-22. This embodiment of the software has particular application in extracting search shapes from vector format files such as those produced by commonly available AutoCAD software. FIG. 12 is a representation of a screen display or printed output of an example vector file. As shown, the file contains information defining a page 100 which includes a border 102, a title block 104, a main image 106 that has a shape 108 and a boundary box 109, dimension information 110, a second image 112, and a third image 114.

Shape 108 includes an interior space 116 that is bounded by a plurality of line segments and arcs. Specifically, a first portion of interior space 116 is enclosed by line segments 118, 120, and 122. The larger, central portion of interior space 116 is enclosed by parallel line segments 124, 126 and parallel line segments 128, 130. Line segment 120 is connected to line segment 128 by arc 132. Similarly, line segments 128, 124, line segments 124, 130, and line segments 130, 126 are connected together by arcs 133, 135, and 137, respectively. Line segment 126 is connected to line segment 122 by end point 144. Line segment 122 is connected to line segment 118 by end point 146. Finally, line segment 118 is connected to line segment 120 by end point 148. Shape 108 also includes a line segment 138 extending from end point 148 and a pair of line segments 134, 136 extending from opposite ends of line segment 130. Line segment 134 intersects with boundary box 109 at end point 140. Similarly, line segment 136 intersects with boundary box 109 at end point 142.

Boundary box 109 includes line segments 150, 152, 154, and 156. Line segment 150 is connected to line segment 152 by end point 158. Similarly, line segments 152, 154, line segments 154, 156, and line segments 156, 150 are connected by end points 160, 162, and 164, respectively. Dimension information 110 includes dimension lines 168, 184, arrow heads 170, 180, line segments 172, 182, and dimension letter 174. Dimension letter 174 is the letter “A,” and includes legs 176, 178 and triangular body 179.

Second image 112 includes an interior space 186 bounded by line segments 188, 190, 192, and 194. A line segment 196 extends from line segment 194 and is connected to line segment 194 by end point 204. Line segments 188, 190 and line segments 190, 192 are connected by arcs 198, 200, respectively. Line segment 192 is connected to line segment 194 by end point 202. Second image 112 further includes a line segment 206 connected to an arrow head 208. A dimension letter 210 (the letter “D”) is associated with arrow head 208.

Third image 114 includes an interior space 212 bounded by an arc 214, and line segments 216, 220. An extension 218 is connected to line segment 216, and an extension 222 is connected to line segment 220. Line segments 216, 220 are connected by end point 224. An additional line segment 226 extends from end point 224. Third image 114 further includes an angle letter 228 (the letter “C”).

It is customary to prepare drawings in vector format by creating the various portions of the finished drawing in layers. Often, generic drawing information representing, for example, border 102 and title block 104, is assigned a layer separate from the remainder of the drawing content. Various images on the drawing may be created on separate layers. Additionally, dimension information, notes, and other types of information may be created on additional layers. It is also common practice to assign various colors to certain portions of the content of a vector format drawing so that these portions are easily distinguishable from other portions when all of the various layers of the drawing or overlaid on a screen of a monitor or printed in physical form. For example, dimension information maybe assigned one color, while the lines and arcs used to create the main image of the drawing are assigned a different color. Similarly, the widths of the lines and arcs used to create these separate components of the overall drawing maybe varied to further distinguish the different components of the drawing and to enhance the clarity of the composite view.

It should also be understood that many target search shapes, for example, the shapes of mechanical components, include arcs or radiused corners to account for the limitations of the manufacturing process. For example, it is very difficult to create an inside corner that terminates in a point (e.g., a perfect right angle) because the tools for cutting or forming a physical item cannot have an infinitely small width. Even a laser beam has a finite diameter which creates a radiused inside corner. Accordingly, shape 108 of FIG. 12 includes arc 132 which represents a radiused inside corner. Additionally, arcs 133, 135, and 137 represent radiused corners which are common in drawings of physical articles of manufacture. Likewise, second image 112 includes arcs 198, 200 which represent radiused outside corners.

The method for extracting a search shape from a vector format drawing described below is used in the process of identifying a search shape for comparison to other shapes and in the indexing procedure for creating a database of shapes against which the search shape is compared. More specifically, a plurality of vector format files may be processed by performing the steps described below to create a database of shapes for future searching.

In one embodiment of the invention, the software employs the application program interfaces (APIs) accompanying the drawing generation software to enable the user to select a particular vector format file for shape extraction. Of course, a plurality of files may be selected for processing as a group, for example, prior to execution of an indexing procedure. Once the file is selected, the page, such as page 100 of FIG. 12, may be displayed to the user on a computer screen. If a plurality of files are selected for batch processing as part of an indexing procedure, the files typically would not be displayed to the user. Furthermore, the following description of user-selected layers and search shape verification typically would not apply to processing of a group of files. The software of the present invention may provide the user with a dialogue box requesting the user's input regarding which layer (or layers) of page 100 most likely includes the desired search shape, and which layer (or layers) most likely does not include the desired search shape. Assuming the user has some knowledge of the drawing conventions used to generate vector format drawings in a particular organization, the user can provide the requested information to permit the software to more quickly locate the desired search shape as will be further described below. For example, the user may know that border 102 and title block 104 are, according to standard practices within the organization, always generated on layer 1 of any vector format drawing. The user would then respond to the dialogue box by indicating that layer 1 is not likely to contain the desired search shape.

In the following example, it is assumed that page 100 of FIG. 12 includes three layers: layer 1 includes border 102 and title block 104; layer 2 includes main image 106, dimension information 110, and third image 114; and layer 3 includes second image 112. For the purposes of this example, it is further assumed that the user indicated in response to the dialogue box that layer 1 is not likely to contain the desired search shape and that it is equally likely that the search shape is located on layer 2 or layer 3.

In one embodiment of the present invention, the software employs the drawing software APIs to extract each layer identified by the user as possibly including the desired search shape. As a preliminary step, the content of these layers is searched to determine whether the layer includes an arc. As indicated above, arcs or radiused corners are typically used on component drawings. Thus, a layer that includes no arcs will likely not include a search shape. Accordingly, the software processes only the layers that were identified by the user as possibly including the desired search shape and include an arc. Other layers, even if identified by the user as possibly including a search shape, are ignored. It should be understood, however, that if none of the layers identified by the user include an arc, the software may either ask the user for additional layer candidates, or simply continue processing all layers of page 100 until a layer including an arc is identified.

In this example, the software first processes layer 2 (including main image 106, dimension information 110, and third image 114) because layer 2 was identified by the user as likely including the desired search shape, and also includes a plurality of arcs. The content of layer 2 is next analyzed to determine the characteristics of the lines and arcs contained therein. According to one embodiment of the invention, the lines and arcs are separated into sub-layers, each containing lines and arcs having common characteristics. Specifically, a sub-layer may be defined as including all lines and arcs having the same color and the same width. In this example, it is assumed that dimension information 110 includes only lines having the same color and the same width. Similarly, it is assumed that main image 106 includes only lines and arcs having the same color and width, but a different color or width from those included in dimension information 110. Finally, it is assumed that the lines and arcs included in third image 114 have the same color and width characteristics, but are different in either color or width from both dimension information 110 and main image 106. As such, the content of layer 2 is separated into the three sub-layers as depicted in FIGS. 13A-C.

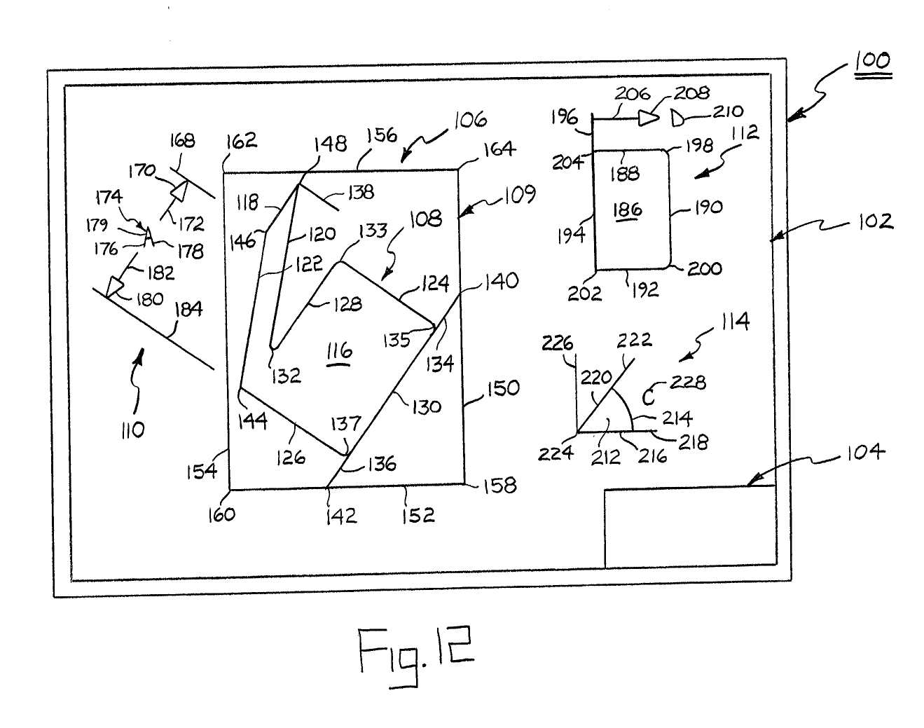

After each sub-layer is identified, the software performs an iterative process of eliminating lines and arcs having open ends (i.e., lines and arcs not connected at both ends to other lines or arcs). The process of removing open ended lines and arcs is terminated for each sub-layer when an iteration fails to remove any of the content of the sub-layer. By comparing FIG. 13A to FIG. 14A, it is apparent that dimension lines 168, 184, line segments 172, 182, and legs 176, 178 of dimension letter 174 are removed by application of the above-described iterative process. The only objects remaining in the sub-layer depicted in FIG. 14A are arrow heads 170, 180 and triangular body 179 of dimension letter 174. Similarly, a comparison of FIGS. 13B and 14B shows that line segment 138 extending from shape 108 has been removed. Finally, a comparison of FIGS. 13C and 14C shows that angle letter 228 and line segments 222, 218, and 226 have been removed. As should be apparent from the foregoing, the content of each of the sub-layers shown in FIGS. 14A-C includes only closed shapes.

The software next further divides each sub-layer into sub-sub-layers, that each include a single closed shape from the corresponding sub-layer. The process of identifying individual, closed shapes includes locating end points in the sub-layer and determining whether other lines or arcs are connected to the located end point. If such a connection exists, the connected lines and arcs are grouped together in a sub-sub-layer as an individual, closed shape. Referring to FIG. 14A, it is readily apparent that three closed shapes are present (arrow heads 170, 180 and triangular body 179). Accordingly, as shown in FIGS. 15A-C, each of these shapes is separated into its own sub-sub-layer.

Referring to FIG. 14B, line segment 134 terminates at one end at an end point common between arc 135, line segment 130, and line segment 134. Similarly, one end of line segment 136 is joined with arc 137 and line segment 130 at a common end point. The opposite end of line segment 134 terminates at end point 140. End point 140, however, is located along the length of line segment 150, not at either of the end points 164, 158. Accordingly, line segment 134 is not grouped with the line segments connected to line segment 150 (i.e., the line segments included in boundary box 109). Likewise, the opposite end of line segment 136 terminates at end point 142 which falls along the length of line segment 152. Since line segment 136 does not share a common endpoint with line segment 152, line segment 136 is not grouped with line segment 152. The result of the above-described process with respect to the sub-layer depicted in FIG. 14B is two separate, closed shapes as shown in FIGS. 15D and 15E. Specifically, the sub-sub-layer depicted in FIG. 15D includes boundary box 109 (including the line segments connected at end points 158, 160, 162, and 164). The sub-sub-layer depicted in FIG. 15E includes shape 108 (including line segments 134, 136).

Since the sub-layer depicted in FIG. 14C includes only one closed shape (hereinafter referred to as shape 230), the above-described process results in a single sub-sub-layer, depicted in FIG. 15F, that is identical to the sub-layer depicted in FIG. 14C.

Once the individual, closed shapes are separated into sub-sub-layers, each sub-sub-layer may be searched to determine whether it includes an arc. As explained above, shapes that do not include at least one arc are not likely to be the desired search shape since they do not likely correspond to an article of manufacture. As should be apparent from the foregoing, application of this step to the sub-sub-layers depicted in FIGS. 15A-F results in the elimination of the sub-sub-layers depicted in FIGS. 15A-D.

The above-described process of separating closed shapes contained in individual sub-layers may result in the creation of lines or arcs having open ends. For example, by separating boundary box 109 and shape 108 into separate sub-sub-layers as shown in FIGS. 15D and 15E, respectively, end points 140, 142 of line segments 134, 136, respectively, were transformed into open end points. The software according to the present invention again applies the iterative process described above for removing lines and arcs having open ends. Line segments 134, 136 are thus removed in the process.

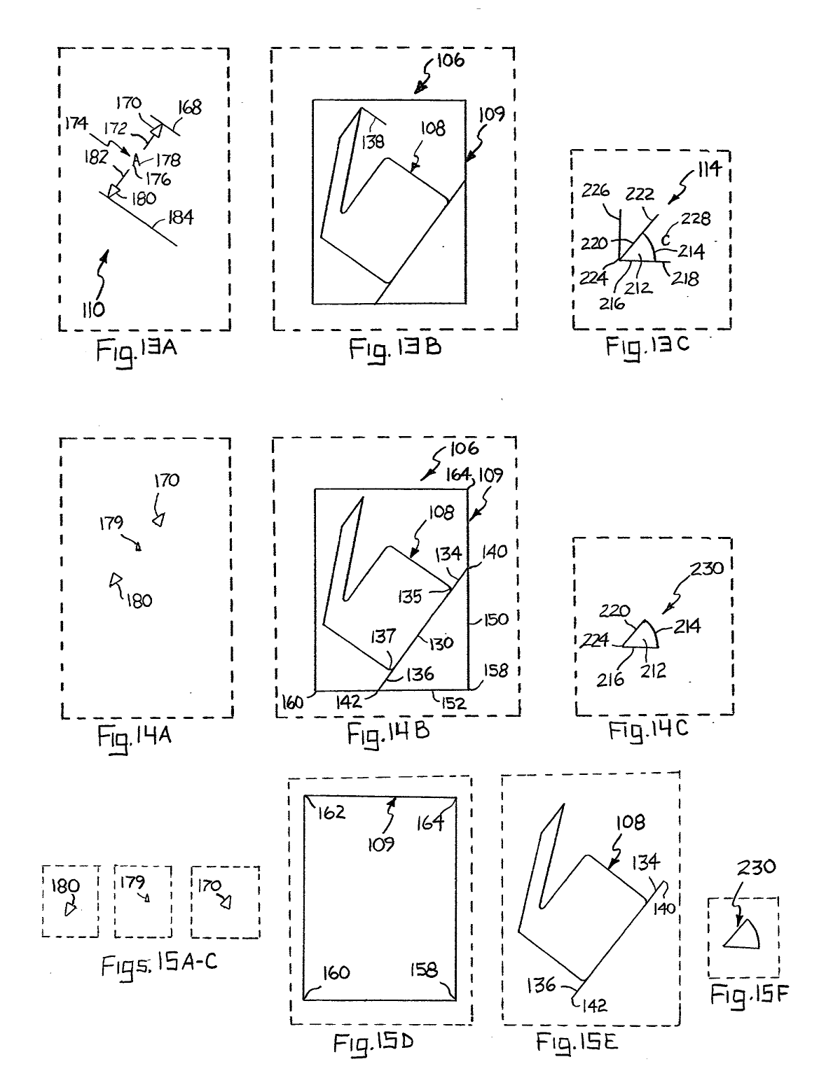

FIGS. 16A and 16B depict the sub-sub-layers surviving the above-described processes. The sub-sub-layer depicted in FIG. 16A includes shape 108 (without line segments 134, 136). The sub-sub-layer depicted in FIG. 16B includes shape 230, and is identical to FIG. 15F since shape 230 did not include lines or arcs with open ends. The software next compares the area enclosed by each of the shapes contained in the surviving sub-sub-layers to identify the largest shape. As should be apparent from the figures, this comparison step identifies shape 108 as the most likely candidate for the desired search shape contained within layer 2.

The above-described steps are next applied to layer 3 of page 100. As explained above, layer 3 includes second image 112 (FIG. 12). For this example, it is assumed that line segment 196 and the line segments and arcs enclosing interior space 186 share the same color and width characteristics. It is further assumed that dimension letter 210, arrow head 208, and line segment 206 share color and width characteristics that are different from the other line segments and arcs of second image 112. The software thus defines the sub-layers of layer 3 as depicted in FIGS. 17A and 17B.

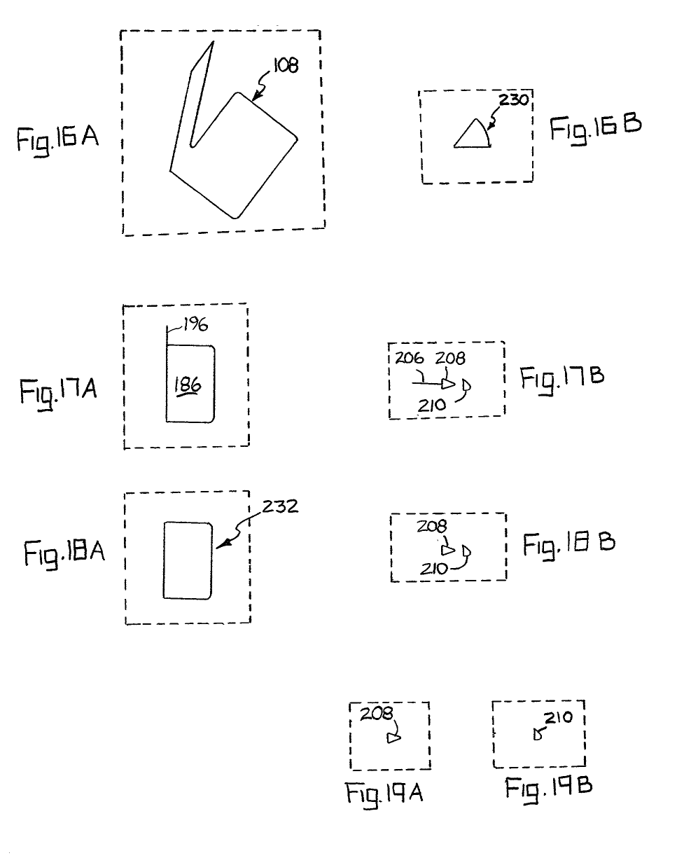

The above-described iterative process of removing lines and arcs having open ends is next applied to the sub-layers depicted in FIGS. 17A and 17B. As a result of application of this process to the sub-layer depicted in FIG. 17A, line segment 196 is removed, leaving the closed shaped (hereinafter referred to as shape 232) shown in FIG. 18A. As shown in FIG. 18B, application of the iterative process to the sub-layer depicted in FIG. 17B results in removal of line segment 206.

The software according to the present invention next further divides the sub-layers into sub-sub-layers using the process described above identifying common ends point and grouping connected line segments and arcs. As should be apparent from the figures, the sub-layer depicted in FIG. 18A cannot be further sub-divided. The sub-layer depicted in FIG. 18B, on the other hand, is divided into the sub-sub-layers depicted in FIGS. 19A and 19B.

Next, each of the sub-sub-layers that do not include an arc are eliminated. In this example, the sub-sub-layer depicted in FIG. 19A is eliminated. Dimension letter 210 is retained (FIG. 19B) since the letter “D” includes an arc. The iterative process of removing line segments and arcs having open ends is next applied to shape 232 (FIG. 18A) and dimension letter 210 (FIG. 19B). Of course, since neither shape 232 nor dimension letter 210 includes open ended line segments or arcs, the iterative process will terminate after the first iteration. The surviving shapes from layer 3 (shape 232 of FIG. 18A and dimension letter 210 of FIG. 19B) are compared to one another to determine which shape has the greatest enclosed area. Thus, shape 232 is identified as the most likely candidate for the desired search shape contained in layer 3 of page 100.

After each of the layers of a particular page are processed as described above, the single shapes resulting from each layer are compared to one another to identify the shape having the largest enclosed area. In this example, shape 108 (FIG. 16A) is compared to shape 232 (FIG. 18A). Consequently, shape 108 is identified as being the most likely desired search shape from the layers processed as described above.

At this point in the process, shape 108 may be reproduced and displayed to the user to verify that it is the desired search shape. It is possible, for example, that the user failed to identify the layer of a particular drawing that includes the desired search shape. However, the layers that the user specified as most likely containing the desired search shape will nonetheless be processed according the above-described steps. This process may result in identification of a single shape, but not the desired search shape. Thus, by providing the user an opportunity to verify the located search shape, the software may avoid performing a futile search. Of course, if a group of files are being processed as part of an indexing routine, a user-verification feature would not typically be provided.

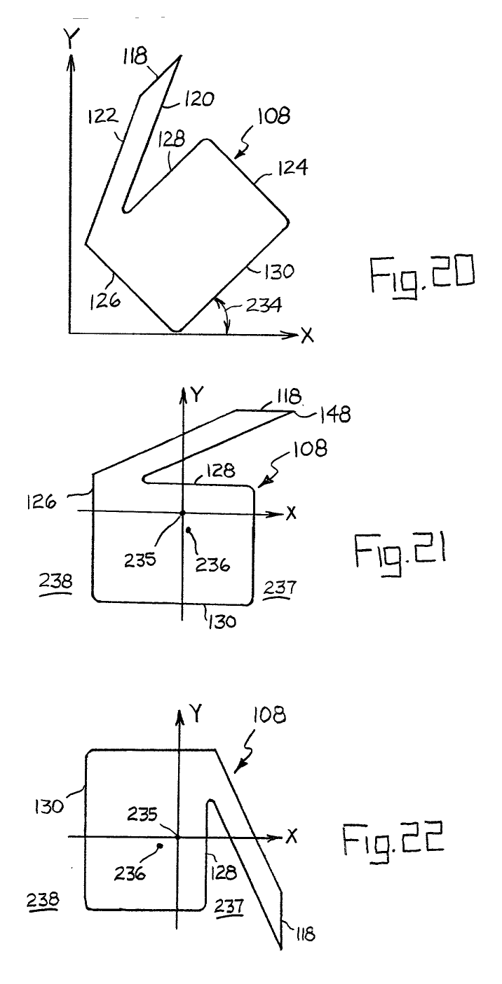

FIG. 20 depicts shape 108 in its original orientation as generated on page 100 of FIG. 12. As described above in the discussion of bitmap searching, it is desirable to orient a search shape in a predetermined orientation so as to increase the speed of a search, as well as the likelihood of accurately identifying matches. When processing a search shape from a vector format drawing, the software according to the present invention, in effect, imposes x and y axes for use in rotating the search shape into an orientation wherein the majority of line segments are parallel to the x axis. In this example, by analyzing the vector information associated with each line segment of shape 108, the software determines that line segment 120 is parallel to line segment 122, line segment 124 is parallel to line segment 126, and line segments 118, 128, and 130 are parallel to one another. The largest group of parallel line segments includes line segments 118, 128, and 130. Thus, the angle of rotation (depicted as angle 234) is measured from any one of those three line segments to the x axis. Shape 108 is then rotated such that line segments 118, 128, and 130 are parallel to the x axis.

As shown in FIG. 21, a center point 235 may be defined on shape 108 by, for example, bisecting the greatest dimension of shape 108 in the x direction, and bisecting the greatest dimension of shape 108 in the y direction. Specifically, the distance between line segment 126 and end point 148 may be divided by two to locate a point through which the vertical y axis passes as shown in FIG. 21. Similarly, the x axis may be defined as a line midway between, and parallel to line segments 118, 130. The intersection between the x and y axes may be defined as the physical center 235 of shape 108.

Next, using well established methods, the center of mass 236 of shape 108 may be calculated. As shown in FIG. 21, the center of mass of shape 108 lies in quadrant 237 of the above-defined coordinate system. In this example, it is assumed that the predetermined orientation requires the center of mass of a search shape to lie in the lower left quadrant 238 as viewed in FIG. 21. Accordingly, shape 108 is rotated either clockwise or counterclockwise in 90 degree increments until center of mass 236 is located in quadrant 238 as shown in FIG. 22. As described in the discussion of shape extraction of bitmap drawings, once a search shape is moved to the predetermined orientation, it may be compared to a database of similarly oriented shapes to identify similar or identical shapes extracted from other files or contained in other drawings.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. A method of indexing shapes including the steps of:
inputting a digital page into a computer system, the digital page including information including a shape and extraneous information;
removing the extraneous information; and
orienting the shape in a predetermined orientation.

2. The method of claim 1 wherein the extraneous information includes a border and a title block.

3. The method of claim 1 wherein the step of removing the extraneous information includes the step of identifying a border and a title block and removing the border and the title block.

4. The method of claim 3 wherein the step of identifying a border and a title block includes the steps of locating pixels adjacent a perimeter of the digital page that correspond to extraneous information, and performing a line fit analysis using the pixel locations to determine whether the pixels lie on a line.

5. The method of claim 1 wherein the step of removing the extraneous information includes the step of reducing the shape for faster processing.

6. The method of claim 1 wherein the step of removing the extraneous information includes the steps of identifying all objects on the digital page, assuming the shape is the largest object on the page, and removing all objects except the largest object.

7. The method of claim 6 wherein the step of identifying all objects on the digital page includes the step of locating adjacent pixels of information on the digital page, and defining objects as collections of contiguous pixels of information.

8. The method of claim 1 wherein the step of removing the extraneous information includes the step of backfilling the digital page to locate an interior space of the shape.

9. The method of claim 8 wherein the step of backfilling includes the steps of backfilling a portion of the digital page outside the shape with a first color, and filling all other portions of the digital page with a second color.

10. The method of claim 1 wherein the step of removing the extraneous information includes the step of removing information having a width of a single pixel.

11. The method of claim 1 wherein the step of orienting the shape includes the step of identifying the center of mass of the shape.

12. The method of claim 1 wherein the step of orienting the shape includes the step of rotating the shape.

13. The method of claim 11 further including the step of rotating the shape so that the center of mass is in a predetermined location relative to a pair of axes.

14. The method of claim 1 wherein the information includes layers of information.

15. The method of claim 14 wherein the step of removing the extraneous information includes the step of asking a user to identify a layer that likely contains the shape and a layer that does not likely contain the shape.

16. The method of claim 15 wherein the step of removing the extraneous information includes the step of determining whether the layer identified as likely containing the shape includes an arc.

17. The method of claim 14 wherein the step of removing the extraneous information includes the step of ignoring layers of information that do not include an arc.

18. The method of claim 14 wherein the step of removing the extraneous information includes the step of defining a sub-layer of information as including information from a layer having a common characteristic.

19. The method of claim 18 wherein the common characteristic is one of color and width.

20. The method of claim 18 wherein the step of removing the extraneous information includes the step of removing any lines and arcs within the sub-layer having an open end point.

21. The method of claim 18 wherein the step of removing the extraneous information includes the step of defining a sub-sub-layer of information as including information from the sub-layer forming a closed shape.

22. The method of claim 21 wherein the step of defining a sub-sub-layer includes the step of removing any lines and arcs within the sub-sub-layer having an open end point.

23. The method of claim 14 wherein the step of removing extraneous information includes the step of identifying, for each of a plurality of layers, an object having an area that is larger than the area of any other object on the particular layer.

24. The method of claim 23 wherein the step of removing extraneous information includes the step of comparing the objects identified as having the largest area on their particular layer to identify the largest object on the digital page.

25. The method of claim 1 wherein the step of orienting the shape in a predetermined orientation includes the step of determining an angle relative to an x axis that is common to a largest number of lines included in the shape.

26. The method of claim 25 wherein the step of orienting the shape in a predetermined orientation includes the step of rotating the shape by an angle that is equal to the common angle.

27. The method of claim 26 wherein the step of orienting the shape of includes the step of determining a physical center of the shape and a center of mass of the shape.

28. The method of claim 27 wherein the step of orienting the shape includes the steps of defining a pair of perpendicular axes that pass through the physical center and rotating the shape relative to the axes so that the center of mass is located in a predetermined quadrant defined by the axes.

29. A method of identifying shapes stored in a database that are identical or similar to a search shape, including the steps of:
inputting a drawing including information including the search shape and other information;
eliminating the other information;
calculating the center of mass of the search shape;
positioning the search shape so that the center of mass is in a predetermined orientation; and
comparing the search shape to the shapes stored in the database.

30. The method of claim 29 further including the step of outputting the stored shapes that are identical or similar to the search shape.

31. The method of claim 29 wherein the step of eliminating the other information includes the step of identifying a border and a title block and removing the border and the title block.

32. The method of claim 31 wherein the step of identifying a border and a title block includes the steps of locating pixels of information adjacent a perimeter of the drawing and determining whether the located pixels lie on a line.

33. The method of claim 29 wherein the step of eliminating the other information includes the step of reducing the search shape for faster processing.

34. The method of claim 29 wherein the step of eliminating the other information includes the steps of identifying all objects on the drawing, assuming the search shape is the largest object, and removing all objects except the largest object.

35. The method of claim 34 wherein the step of identifying all objects on the drawing includes the step of locating adjacent pixels of information on the drawing, and defining objects as collections of contiguous pixels of information.

36. The method of claim 29 wherein the step of eliminating the other information includes the step of backfilling the drawing to define an interior space of the search shape.

37. The method of claim 36 wherein the step of backfilling includes the steps of backfilling a portion of the drawing outside the search shape with a first color, and filling other portions of the drawing with a second color.

38. The method of claim 29 wherein the step of eliminating the other information includes the step of removing information having a width of less than a predetermined number of pixels.

39. The method of claim 29 wherein the step of positioning the search shape includes the step of rotating the search shape so that the center of mass is in a predetermined orientation relative to a pair of axes.

40. The method of claim 29 wherein the information includes layers of information.

41. The method of claim 29 wherein the step of eliminating the other information includes the step of asking a user to identify a layer that likely contains the search shape and a layer that does not likely contain the search shape.

42. The method of claim 41 wherein the step of eliminating the other information includes the step of determining whether the layer identified as likely containing the search shape includes an arc.

43. The method of claim 40 wherein the step of eliminating the other information includes the step of ignoring layers of information that do not include an arc.

44. The method of claim 40 wherein the step of eliminating the other information includes the step of defining sub-layers of information from a layer of information, the information of each sub-layer having a common characteristic.

45. The method of claim 44 wherein the common characteristic is one of color and width.

46. The method of claim 44 wherein the step of eliminating the other information includes the step of removing, within each sub-layer, any lines and arcs having an open end point.

47. The method of claim 44 wherein the step of eliminating the other information includes the step of defining, for each sub-layer including a closed shape, a sub-sub-layer of information including the closed shape.

48. The method of claim 47 wherein the step of defining a sub-sub-layer includes the step of removing any lines and arcs within the sub-sub-layer having an open end point.

49. The method of claim 40 wherein the step of eliminating the other information includes the step of identifying, for each layer, an object having an area that is larger than the area of any other object on the particular layer.

50. The method of claim 49 wherein the step of eliminating the other information includes the step of comparing the objects identified as having the largest area on their particular layer to identify the largest object on the drawing.

51. The method of claim 29 wherein the step of positioning the search shape includes the step of determining an angle relative to an x axis that is common to a largest number of lines included in the search shape.

52. The method of claim 51 wherein the step of positioning the search shape includes the step of rotating the search shape by an angle that is equal to the common angle.

53. The method of claim 52 wherein the step of positioning the search shape of includes the step of determining a physical center of the search shape.

54. The method of claim 53 wherein the step of positioning the search shape includes the steps of defining a pair of perpendicular axes that pass through the physical center and rotating the shape relative to the axes so that the center of mass is located in a predetermined quadrant defined by the axes.

55. A shape retrieval program including:
an indexing routine for generating a database of indexed shapes by processing shapes included on inputted drawings also having extraneous information, the indexing routine including a procedure for removing the extraneous information on each inputted drawing, a procedure for orienting the indexed shape in a predetermined orientation, and a procedure for storing the indexed shape in the database; and
a querying routine for identifying any indexed shapes that are similar or identical to a search shape included on an inputted search drawing also having extraneous information, the querying routine applying the removing procedure to the search drawing and the orienting procedure to the search shape, and including a procedure for comparing the search shape to the indexed shapes.

56. The program of claim 55 wherein the procedure for removing the extraneous information identifies a border and a title block on each inputted drawing and removes the border and the title block.

57. The program of claim 55 wherein the procedure for removing the extraneous information identifies all objects on the inputted drawing, defines the indexed shape as the largest object on the drawing, and removes all objects except the largest object.

58. The program of claim 55 wherein the procedure for removing the extraneous information identifies all objects on the inputted drawing by locating adjacent pixels of information and defining objects as collections of contiguous pixels of information.

59. The program of claim 55 wherein the procedure for removing the extraneous information back fills the inputted drawing to define an interior space of the indexed shape.

60. The program of claim 59 wherein the step of backfilling includes the steps of backfilling a portion of the drawing outside the indexed shape, and filling all other portions of the drawing with a second color.

61. The program of claim 55 wherein the procedure for removing the extraneous information includes removing pixels of information about a perimeter of the indexed shape.

62. The program of claim 55 wherein the orienting procedure calculates the center of mass of the indexed shape.

63. The program of claim 55 wherein the orienting procedure rotates the indexed shape by an amount corresponding to a most common angle of the indexed shape.

64. The program of claim 62 wherein the orienting procedure rotates the indexed shape so that the center of mass is in a predetermined location relative to a pair of axes.

65. The program of claim 55 wherein the procedure for removing the extraneous information includes separating each closed object on the drawing from the remainder of information on the drawing, and identifying the largest closed object as the indexed shape.

65. A system for generating a database of shapes and for searching the database for shapes that correspond to a shape provided on a drawing having other objects, including:
means for inputting the drawing into the system;
means for removing the other objects;
means for orienting the shape in a predetermined orientation;
means for storing the oriented shape in the database; and
means for comparing the oriented shape to the shapes in the database.
